(19) United States
(12) Patent Application Publication
(10) Pub. No.: US 2021/0245274 A1
(43) Pub. Date: Aug. 12, 2021

(54) CIRCULAR MILLING TOOL AND CIRCULAR MILLING METHOD

(71) Applicant: Guehring KG, Albstadt (DE)

(72) Inventor: Bruno TEUSCH, Esslingen (DE)

(73) Assignee: Guehring KG, Albstadt (DE)

(21) Appl. No.: 17/181,009

(22) Filed: Feb. 22, 2021

Related U.S. Application Data
(63) Continuation of application No. PCT/DE2019/000217, filed on Aug. 13, 2019.

(30) Foreign Application Priority Data
Aug. 22, 2018 (DE) 10 2018 214 192.4

(51) Int. Cl. B23C 5/04; B23C 3/34

(52) U.S. Cl. CPC B23C 5/04; B23C 2220/36; B23C 2210/244; B23C 3/34

(57) ABSTRACT

A circular milling tool for producing a microgroove structure in a cylindrical surface of a bore, the microgroove structure having a groove profile defined by plural microgrooves axially spaced apart and peripherally extend in a circular manner, comprising:
a tool base body drivable around an axis of rotation, which carries a circumferential cutter set with first and second circumferential cutters, which are arranged in a row in the circumferential direction,
the first circumferential cutter and second circumferential cutter each have a cutting profile that differs from the groove profile of the microgroove structure to be produced, and
the circumferentially projected cutting profiles of the circumferential cutters of the circumferential cutter set overlap each other in an axial direction to an extent that they jointly image the defined groove profile of the microgroove structure to be generated. Also, a method for producing a microgroove structure in a bore.

The invention relates to a circular milling tool and a method for producing a microgroove structure in the cylindrical surface of a bore in particular in a metallic workpiece, e.g., a cylinder bore in a combustion engine.

As sufficiently known, tribologically highly stressed surfaces of bores in metallic workpieces, e.g., the piston running surfaces of cylinder bores or cylinder liners in a combustion engine, are mechanically roughened, for example with the help of cutting tools, so as to obtain a good adhesive base for a surface layer to be applied in particular via thermal spraying.

For this purpose, for example, DE 10 2016 216 464 A1 proposes a circular milling tool with a tool base body that can be rotationally driven around an axis of rotation and a plurality of circumferentially cutting side milling cutters arranged axially staggered on the tool base body. Each side milling cutter comprises several cutting elements arranged in a row in the circumferential direction, which each form a multitoothed circumferential cutter, which is adjoined on the cutting direction side by a cutting face or chip surface. The circumferential cutters of each side milling cutter have the same filigree cutting edge profile, which is defined by a plurality of identically sized cutting teeth spaced apart at the same axial distances, wherein the dimensions of the cutting teeth (tooth width, tooth height) each lie in the μm range, for example within a range of 100 to 200 μm.

Since the circumferential cutters of each side milling cutter are axially arranged at the same height and have the same cutting profile, they leave a corresponding number of filigree cut marks in the surface that corresponds to the number of cutting teeth per circumferential cutter during the circular milling of a cylindrical surface. In sum, the cut marks of the cutting elements arranged in a row in the circumferential direction yield a microgroove structure with a groove profile, which corresponds to the cutting profile of the circumferential cutters and is defined by a plurality of microgrooves that are axially spaced apart and peripherally extend in a circular manner, wherein the cross sectional profile of a microgroove, in particular the groove width measured in an axial direction, corresponds to the tooth profile, i.e., the tooth width, of a cutting tooth. In a separate drilling or milling operation that follows the circular milling operation, the inner diameter of the webs separating the microgrooves from each other, i.e., the inner diameter of the microgroove structure, is enlarged to a predefined desired diameter by means of a separate drilling or milling tool.

The circular milling tool proposed in DE 10 2016 216 464 A1 is characterized in that a microgroove structure with a groove profile defined by a plurality of axially spaced apart microgrooves peripherally extending in a circular manner can be reproducibly produced via the 360° circular milling of a cylindrical surface that can be relatively easily realized in terms of control engineering. However, diameter machining, i.e., finishing, the microgroove structure requires further drilling or milling, and another drilling or milling tool in addition to the circular milling tool.

In addition, the cutting elements arranged in a row in the circumferential direction have the same cutting profile, as a result of which the chip width of the chips that accumulate during circular milling is equal to the tooth width of the cutting teeth or equal to the groove width of the microgrooves. In particular during serial production, chips can thus easily become jammed between the circular milling tool and the machined bore surface. Jammed clips can result in a reduced service life of the circumferential cutters, i.e., the cutting elements, of the circular milling tool due to a strong thermal and mechanical stress on the filigree cutting profiles on the one hand, and jeopardize the desired reproducibility of the defined groove profile of the microstructure to be produced on the other.

Proceeding from DE 10 2016 216 464 A1, the object of the invention is thus to provide a circular milling tool for producing a microgroove structure with a groove profile that is defined by a plurality of microgrooves that are axially spaced apart and peripherally extend in a circular manner, which allows a cylindrical bore surface to be milled more efficiently, in particular during serial production.

This object is achieved by a circular milling tool with the features in claim 1. Advantageous further developments and preferred embodiments are the subject of dependent claims.

A circular milling tool according to the invention finds application for roughing the cylindrical surface of a bore in an in particular metallic workpiece, e.g., a cylinder bore in a combustion engine, by producing a microgroove structure having a groove profile defined by a plurality of microgrooves that are axially spaced apart and peripherally extend in a circular manner. The defined groove profile of the microgroove structure to be produced will also be referred to as the end profile below. The respective dimensions of the microgrooves (the groove width measured in the axial direction and the groove depth measured in the radial direction for each microgroove) lie in the μ range, for example within a range of 100 to 400 μm.

Similarly to the circular milling tool proposed in DE 10 2016 216 464 A1, a circular milling tool according to the invention has a tool base body that can be driven around an axis of rotation, and directly or indirectly carries at least one circumferential cutter set, but preferably several axially staggered circumferential cutter sets. Each circumferential cutter set comprises several, i.e., at least two, cutting elements, which are arranged in a row in a rotational or circumferential direction, and each form a circumferential cutter that is adjoined by a cutting face or chip surface. Each circumferential cutter set thus has at least two circumferential cutters, which comprise at least one first circumferential cutter and at least one second circumferential cutter. The several circumferential cutters per circumferential cutter set are preferably distributed around the axis of rotation at the same angular pitch, i.e., at the same angular distances. However, this is not absolutely necessary, so that the circumferential cutters per circumferential cutter set can also have an unequal angular pitch. Considering the filigree microgroove structure to be produced, however, the circumferential cutters each have a filigree single- or multi-toothed cutting profile. In a multi-toothed cutting profile, the respective dimensions of the cutting teeth (the tooth width measured in an axial direction and the tooth height measured in a radial direction for each cutting tooth) lie in the pm range, for example within a range of 100 to 400 μm. In a single-toothed cutting profile, the tooth height of the cutting tooth measured in a radial direction lies in the pm range, for example within a range of 100 to 400 μm, while the width measured in an axial direction can lie in the mm range, for example within a range of 2 to 50 mm.

On the one hand, as opposed to the circular milling tool proposed in DE 10 2016 216 464 A1, the circumferential cutters of a circular milling tool according to the invention that are arranged in a row in a circumferential direction each have a cutting profile per circumferential cutter set that deviates from the defined groove profile of the microgroove structure. On the other hand, in a circular milling tool according to the invention, the circumferentially projected cutting profiles or chip surfaces of the at least two circumferential cutters overlap each other in an axial direction in such a way or to such an extent that they jointly image the defined groove profile of the microgroove structure to be produced, i.e., the end profile. Understood here by “circumferentially projected” is that the cutting profiles of the at least two circumferential cutters are imaged on a joint longitudinal section plane of the circular milling tool. In other words, overlapping a longitudinal section of a first circumferential cutter with a longitudinal section of a second circumferential cutter (or overlapping longitudinal sections of the at least two circumferential cutters of the circumferential cutter set) images a longitudinal section of a circumferential cutter whose cutting profile corresponds to the end profile.

According to the invention, the at least two circumferential cutters, i.e., the first circumferential cutter and the second circumferential cutter, can have unequal cutting profiles per circumferential cutter set that each deviate from the end profile. As a result of the unequal cutting profiles, the at least two circumferential cutters per circumferential cutter set leave unequal cut marks in a machined workpiece surface. If the at least two circumferential cutters per circumferential cutter set are each multi-toothed in design, the unequal cutting profiles can be realized, for example, by arranging the plurality of cutting teeth of a first circumferential cutter axially offset in an axial direction to for example the same plurality of cutting teeth of a second circumferential cutter. In this case, the cutting teeth of the first circumferential cutter and the second circumferential cutter can be identical or different from each other in terms of their (as viewed in the section direction) tooth profile, e.g., which can be rectangular, trapezoidal, or dovetailed, their (as measured in the axial direction, or maximum) tooth width, their (as measured in the radial direction) tooth height and/or their (as measured in the axial direction) tooth pitch. The use of identical toothed profiles, etc., helps make the circumferential cutters economical to produce and axially compact in design.

For example, unequal cutting profiles can be realized by using cutting elements, which are unequal in terms of tooth profile, tooth width, tooth height and/or tooth pitch, for example plate-shaped, and arranged on the tool base body axially at the same height. In this way, the dimension of a circumferential cutter set measured in an axial direction can be limited at least essentially to the axial dimension of a circumferential cutter.

According to the invention, however, the first circumferential cutter and the second circumferential cutter can also have the same cutting profiles, provided the first circumferential cutter is offset axially relative to the second circumferential cutter by an amount corresponding to the axial overlap. Due to the fact that the circumferential cutters have cutting profiles with a filigree design to produce a microgroove structure, the axial dimension of a circumferential cutter set only increases negligibly by comparison to the axial dimension of a circumferential cutter. For example, the same cutting profiles can be realized by using the same, for example plate-shaped, cutting elements, which are axially offset relative to each other on the tool base body by an amount corresponding to the axial overlap. Using identical cutting elements can help keep manufacturing costs low.

Therefore, it is only crucial that the cut marks of the at least two circumferential cutters per circumferential cutter set that are left behind in a workpiece surface to be machined overlap each other, i.e., complement each other to form an overlapping profile, in such a way or to such an extent that the overlapping profile corresponds to the end profile.

Since the first circumferential cutter and the second circumferential cutter cut into a workpiece to be machined in a time-displaced manner, i.e., one after the other, due to the angular distance, and only produce a part of the end profile, i.e., a respective partial profile, the chipping load per circumferential cutter is lower than if the first and second circumferential cutters were each to produce the complete end profile. Given the series arrangement of the least two circumferential cutters, which each have a cutting profile that differs from the end profile, and the axial overlap of the circumferentially projected cutting profiles of the at least two circumferential cutters, however, the cut marks of the circumferential cutters left behind in the workpiece surface during a circular milling of a cylindrical workpiece surface (bore surface) end up completely imaging the end profile as the result of a 360° circular milling motion of the circular milling tool.

Therefore, the circular milling tool according to the invention enables an efficient milling process for roughening a cylindrical bore surface that is suitable for serial production. Because fewer chips are removed per circumferential cutter than with the circular milling tool proposed in DE 10 2016 216 464 A1, in particular because the width of the chips to be removed is smaller than the width of an end profile, i.e., the width of the grooves of the microgroove structure to be produced, there is less risk that chips will become jammed, and each circumferential cutter is exposed to less stress, which yields a longer tool service life.

In a preferred embodiment, the (at least one) circumferential cutter set comprises at least one first circumferential cutter, preferably several, in particular two, first circumferential cutters, and at least one second circumferential cutter, preferably several, in particular two, second circumferential cutters, which in the axial direction have cutting profile preferably having the same plurality of cutting teeth, i.e., have a multi-tooth cutting profile in an axial direction, i.e., form a multi-tooth circumferential cutter. Each of these multi-tooth circumferential cutters thus has a cutting profile defined by the plurality of axially spaced apart cutting teeth. As a result, a respective partial profile of the end profile corresponding to the cutting profile of the respective circumferential cutter can be produced when the at least one first circumferential cutter and the at least one second circumferential cutter cut into a workpiece surface. An (axial) overlapping of the partial profiles yields the end profile according to the invention.

For a case in which the circumferential cutter set comprises several first circumferential cutters and several second circumferential cutters, the first and second circumferential cutters are alternatingly arranged in the rotational or circumferential direction, i.e., in such a way that a second circumferential cutter follows a first circumferential cutter. Alternatively thereto, however, other arrangements of the first and second circumferential cutters are also possible. For example, the first and second circumferential cutters can be arranged so as to alternate irregularly or alternate pairwise in the rotational direction, i.e., two second circumferential cutters follow two first circumferential cutters.

In the preferred embodiment, every first circumferential cutter can have a different cutting profile than every second circumferential cutter, as already mentioned. In this case, the first and second circumferential cutters can have the same overall width as measured in the axial direction, and be axially arranged at the same height. If the cutting teeth of the first and second circumferential cutters each have a rectangular tooth profile that is defined by a front and rear tooth flank in the axial direction (in an axial infeed direction of the circular milling tool or depth direction of the bore to be machined), for example, the cutting teeth of each first circumferential cutter can be designed for machining the front (or rear) flanks in the axial direction, and the cutting teeth of each second circumferential cutter for machining the rear (or front) flanks of the end profile in the axial direction.

In the preferred embodiment, each first circumferential cutter and each second circumferential cutter can advantageously have the same cutting profile in the preferred embodiment, i.e., the first and second circumferential cutters can have the same design, provided each first circumferential cutter is axially offset against each second circumferential cutter. Because the first circumferential cutters are axially offset relative to the second circumferential cutters in a state mounted on the circular milling tool, the same cutting profiles of the first and second circumferential cutters leave differing cut marks in the bore surface to be machined. In this case as well, the cutting teeth of the first and second circumferential cutters can each have a rectangular tooth profile, which is defined by a front and rear tooth flank in the axial direction (in an axial infeed direction of the circular milling tool or depth direction of the bore to be machined), and the cutting teeth of each first circumferential cutter can be designed for machining the front flanks in the axial direction, and the cutting teeth of each second circumferential cutter for machining the rear flanks of the end profile in the axial direction, for example. Circumferential cutters with the same design advantageously help to simplify the production and assembly of the circular milling tool, and thus to keep costs low.

In the preferred embodiment, the cutting teeth of the first circumferential cutters and/or the second circumferential cutters can alternatively have a nonrectangular tooth profile, e.g., an unsymmetrical tooth profile or another symmetrical tooth profile, for example a trapezoidal tooth profile, in which a tooth width increases or decreases with increasing diameter, i.e., radially toward the outside, or a dovetail profile or a round profile.

In an advantageous further development of the preferred embodiment discussed above, the cutting teeth of each first and second circumferential cutter are preferably arranged spaced apart from each other at the same axial distances, i.e., with the same axial pitch, and/or the cutting teeth of each first and second circumferential cutter preferably have the same tooth widths. A tooth width is here defined by an axial distance between a front cutting edge or tooth flank and a rear cutting edge or tooth flank of a cutting tooth. As an alternative to the preferred embodiment, the cutting teeth of each first circumferential cutter can have a different tooth width than the cutting teeth of each second circumferential cutter. According to the preferred embodiment, however, the tooth widths of the cutting teeth of each first and each second circumferential cutter are each smaller than the groove width of the microgrooves of the end profile. According to the preferred embodiment, the front cutting edges of each cutting tooth of each first circumferential cutter and the rear cutting edges of the accompanying cutting tooth of each second circumferential cutter (wherein associated cutting teeth overlap projected in the circumferential direction) are each arranged spaced apart by the groove width of the end profile.

In a preferred embodiment, the cutting teeth of the rectangular tooth profile have a tooth width of 100 to 400 μm and a tooth height of 50 to 250 μm. An axial distance between the axially adjacent cutting teeth of each first and second circumferential cutter can preferably lie between 200 and 700 μm. An overall width of each first and second circumferential cutter can most preferably lie between 2 and 50 mm.

In an advantageous further development of the preferred embodiment, the cutting profiles of the first circumferential cutter and the second circumferential cutter lie on the same diameter relative to the axis of rotation of the circular milling tool. This means that the circumferential cutting edges of the cutting teeth, i.e., the outer diameter of the cutting profiles, of the first circumferential cutter and the second circumferential cutter lie on a joint cylinder surface around the axis of rotation of the circular milling tool. As a consequence, the cutting profiles of the first circumferential cutter and the second circumferential cutter each only differ from the end profile with respect to the tooth width of the cutting teeth or the groove width of the partial profile.

In an advantageous further development of the preferred embodiment, the at least two circumferential cutters of each circumferential cutter set are arranged at the same angular distances in the circumferential direction, i.e., with the same angular pitch. For example, each circumferential cutter set has eight circumferential cutters, which are arranged at a distance of 45° in the circumferential direction.

In the interest of an especially efficient circular milling, the circumferential cutter set can comprise at least a third circumferential cutter, which has a cutting profile different from the cutting profiles of the first circumferential cutter and second circumferential cutter. This means that the cutting profile of the third circumferential cutter differs both from the cutting profiles of the first circumferential cutter and the second circumferential cutter, and from the defined groove profile of the microgroove structure to the produced, i.e., the end profile. In particular, the end profile is formed by an overlapping of the cutting profiles, i.e., a projection of the cutting profiles in the circumferential direction, of the first circumferential cutter, the second circumferential cutter and the third circumferential cutter.

In a preferred embodiment, the third circumferential cutter is arranged between the first circumferential cutter and the second circumferential cutter. As a result, a chipping load can be uniformly distributed to the first, second and third circumferential cutter, since each circumferential cutter only has to remove the material by which the cutting profile of the circumferential cutter overlaps a cutting profile of an adjacent circumferential cutter. This makes it possible to produce the end profile in an especially efficient and especially reproducible manner.

According to an advantageous further development, the third circumferential cutter can lie on a smaller diameter than the first circumferential cutter and/or the second circumferential cutter. In this case, for example, the groove depth and groove width of the end profile can be produced by the first and second circumferential cutter, while the third circumferential cutter only machines the webs of the bore surface lying between adjacent microgrooves to a defined desired diameter.

In the preferred embodiment, the third circumferential cutter can thus have a single-tooth cutting profile. As a result, a cutting profile with an especially high strength can be provided. The cutting profile thus produces the inner diameter of the bore surface over its entire axial extension.

The cutting tooth of the single-tooth cutting profile of the third circumferential cutter can have an axial tooth width that is essentially as large as the cutting width of the first circumferential cutter and/or the second circumferential cutter. In this case, the third circumferential cutter can machine an area with the same axial width as the first and/or second circumferential cutter and, provided the first, second and third circumferential cutter of a circumferential cutter set are axially arranged at least essentially at the same height, the end profile can be finished by means of a tool.

In the preferred embodiment, the third circumferential cutter can in particular have a wavy cutting profile, which induces an additional roughening by comparison to a straight cutter, so that the surfaces machined by the third circumferential cutter have a defined, uniform roughness over their entire axial extension.

In a further development of the preferred embodiment, the circumferential cutter set has several, in particular four, third circumferential cutters, which each are arranged between one of the several first circumferential cutters and one of the several second circumferential cutters. According to the further development, every third circumferential cutter can lie on a smaller diameter than each first circumferential cutter and each second circumferential cutter, and have a single-tooth cutting profile, i.e., form a single-tooth circumferential cutter, whose cutting tooth has an axial tooth width that is essentially as large as the cutting width of each first circumferential cutter or each second circumferential cutter. As opposed to the respective multi-tooth circumferential cutters of each first circumferential cutter and each second circumferential cutter, the axially overlapping cut marks of which produce a microgroove structure comprising a plurality of axially spaced apart microgrooves, the single-tooth circumferential cutter of each third circumferential cutter can machine the inner diameter of the webs lying between the microgrooves. To this end, each third circumferential cutter can have a wavy cutting profile.

The circumferential cutter set can have a larger number of third circumferential cutters than first circumferential cutters and/or second circumferential cutters. In particular, the number of third circumferential cutters can correspond to the number of first circumferential cutters and second circumferential cutters combined. In particular, the circumferential cutter set can comprise exactly as many circumferential cutters that produce the microgrooves, specifically the first and second circumferential cutters, as circumferential cutters that machine the webs between the microgrooves, and hence the inner diameter, specifically the third circumferential cutters, as a result of which the entire bore area can be uniformly machined.

In a further development of the preferred embodiment, the tool base body of the circular milling tool has a plurality of axially staggered circumferential cutter sets. The preferred embodiment has so many circumferential cutter sets that the entire axial width of the circumferential cutter sets is greater-than-equal-to the depth of the bore surface to be machined. As a result, the bore surface to be machined can be machined over its entire axial extension by a 360° circulation of the circular milling tool, without having to readjust the circular cutting tool in the axial direction or requiring several circular milling operations.

In the preferred embodiment, a respective two axially directly sequential circumferential cutter sets can be twisted against each other around the axis of rotation by a predefined angle. As a result, the circumferential cutters of the two adjacent circumferential cutter sets are arranged one after the other as viewed in the circumferential or cutting direction, so that they cut into the cylindrical surface to be machined in a time-displaced manner. In particular, the circumferential cutter sets are arranged in such a way that respective circumferential cutters that have the same cutting profile are arranged along coils in an axial direction.

This arrangement is suitable for arranging a respective two axially directly sequential circumferential cutter sets in such a way that they overlap each other in an axial direction. This causes the cutting profiles of adjacent circumferential cutter sets that are projected in the circumferential direction to overlap, so that a machined bore surface contains no unmachined surface areas.

In the preferred embodiment, the circumferential cutters, as already mentioned, can each be formed on a cutting element that is indirectly or indirectly fixed on a tool base body, for example shaped like a plate. Modelled after the circular milling tool discussed at the outset, for example, the cutting elements allocated to a circumferential cutter set can be indirectly fixed to the tool base body via a side milling cutter carried by the base body. Because side milling cutters like these are already sufficiently well known, only the first, second or third circumferential cutters have to be designed according to the invention and fastened to the side milling cutter to produce a circular milling tool according to the invention. Alternatively thereto, the cutting elements can be directly secured to the tool base body, e.g., arranged in circumferentially open receiving pockets and fastened in a positive, force-locked and/or material manner.

Regardless of whether the cutting elements are secured indirectly or directly to the tool base body, the circular milling tool can have a number of chip grooves that corresponds to the number of circumferential cutters of a circumferential cutter set. The chip grooves can be worked into the tool base body or produced by, for example, a coiled arrangement of the circumferential cutters, so as to ensure a chip removal that prevents arising chips from being able to become jammed between the tool and bore.

From a functional standpoint, the tool base body can be divided into a carrier section that carries the at least one circumferential cutter set and a shaft section that axially adjoins the carrier section for connecting the circular milling tool with a separating point or interface of a machine tool system, so that the circular milling tool can be used with a machine tool system in a manner known to the expert.

The object of the invention is also achieved with a method for producing a microgroove structure in a bore in an in particular metallic workpiece, e.g., a cylinder bore in a combustion engine, wherein the microgroove structure comprises a plurality of microgrooves that are axially spaced apart and peripherally extend in a circular manner, and each have a defined groove profile. In the method according to the invention, a bore surface is finished by a 360° circulation of a rotary driven circular milling tool according to the invention around the bore axis due to the fact that the cut marks of the circumferential cutters per circumferential cutter set of the circular milling tool that were left behind in the bore surface overlap each other in an axial direction in such a way that they image the defined groove profile of the microgroove structure.

If the at least one circumferential cutter set comprises at least one first circumferential cutter, at least one second circumferential cutter, and at least one third circumferential cutter, a circular milling tool according to the invention can be used in a 360° circulation to reproducibly finish a cylindrical workpiece surface with a microgroove structure, which has a groove profile defined by a plurality of microgrooves that are axially spaced apart and peripherally extend in a circular manner, and lies on a prescribed diameter.

In other words, the circular milling tool is designed in such a way that at least one first circumferential cutter produces a first cut mark in a machined cylindrical workpiece surface that is designed as a first groove profile, which extends in the circumferential direction and corresponds to a part of the end profile, and at least one second circumferential cutter produces a second cut mark designed as a second groove profile, which extends in the circumferential direction and corresponds to a part of the end profile. The first and second groove profile, i.e., the first and second cut mark, are here each designed differently than the end profile. The first and second groove profile here complement each other so as to form the end profile. In particular, the first and second groove profile complement each other in such a way that the first and second groove profile cover each other for the most part, for example by more than 50%, especially preferably by more than 80%. The circumferential cutter set can also have at least one third circumferential cutter, which produces a third cut mark in the workpiece surface, wherein the first, second and third cut mark complement each other to form the end profile.

The invention will be described below with the help of drawings. Shown on:

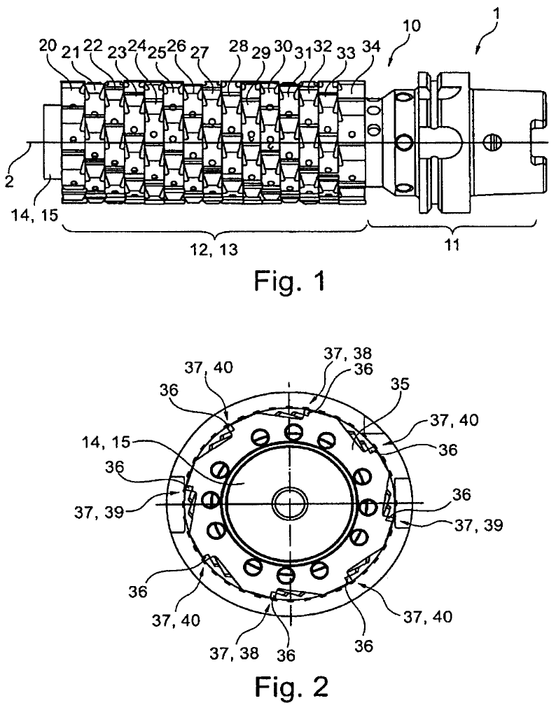

FIG. 1 is a side view of a circular milling tool according to the invention,

FIG. 2 is a front view of the circular milling tool,

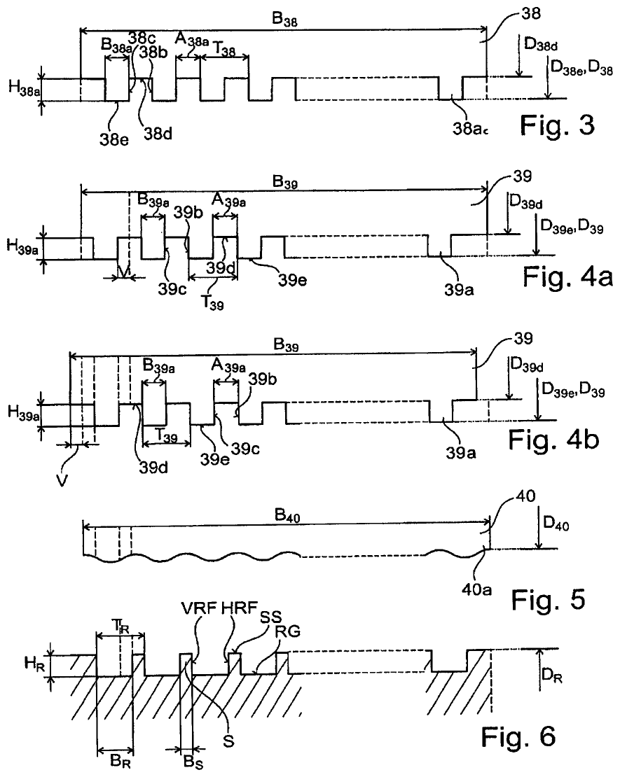

FIGS. 3 to 6 are longitudinal section views of the cutting profiles of the circumferential cutters of the circular milling tool,

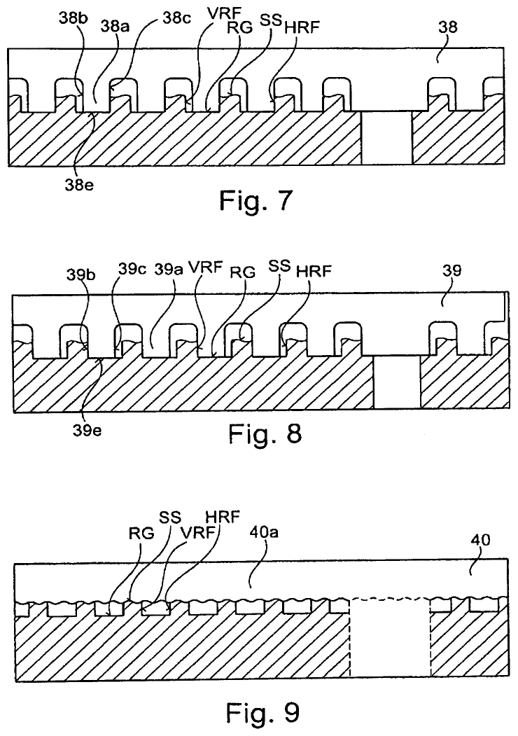

FIGS. 7 to 9 are schematic illustrations of cutting teeth of the cutting profiles engaged in an end profile,

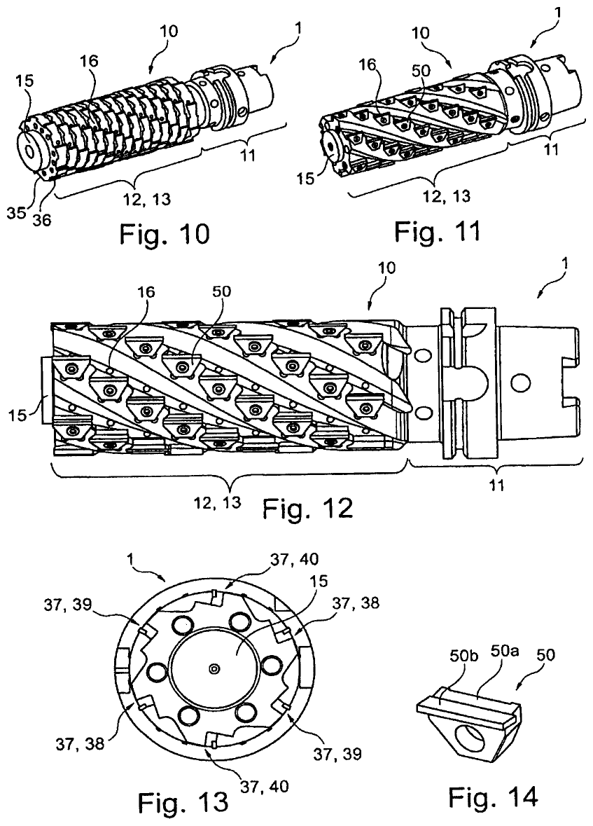

FIG. 10 is a perspective view of the circular milling tool in a first preferred embodiment,

FIGS. 11 to 13 is a perspective view, a side view, and a front view of the circular milling tool in a second preferred embodiment, and

FIG. 14 is a perspective view of a cutting element.

Preferred embodiments of a circular milling tool according to the invention will be described in more detail below with the help of the figures. The figures are only schematic in nature, and serve to provide a better understanding of the invention. Identical elements are labeled with the same reference number. The circular milling tool is conceived for mechanically roughening in a cylindrical surface of a bore in an in particular metallic workpiece, e.g., the piston running surface of a cylinder bore or a cylinder liner in a combustion engine by producing a microgroove structure in the surface. The microgroove structure to be produced here has a defined groove profile, which is defined by a plurality of microgrooves that are axially spaced apart and peripherally extend in a circular manner, so as to achieve a good adhesive base for a surface layer to be applied in particular via thermal spraying. The defined groove profile of the microgroove structure to be produced is referred to as end profile below.

A circular milling tool 1 according to the invention has a tool base body 10, which can be rotary driven around a longitudinal center line or axis of rotation 2, and can be functionally divided into a shaft section 11 and a carrier section 12. The shaft section 11 can be connected with an interface of a machine tool system (not shown), so as to drive the tool base body 10 around the axis of rotation 2. In the embodiment shown, the shaft section 11 has a hollow shank taper (HST). However, the shaft section 11 can also have a steep taper shank or a cylinder shaft for connecting the circular milling tool 1 with the machine tool system, for example.

In a preferred first embodiment shown on FIG. 1, the circular milling tool 1 has a modular design. The carrier section 12 carries a plurality of circumferentially cutting cutting tools 20 to 34, which are arranged at defined axial distances from each other on the tool base body 10, and each formed by a side milling cutter in the embodiment depicted. In the embodiment depicted, the carrier section 12 carries fifteen cutting tools 20 to 34, so that a cutting part 13 is designed with a length of 154 mm, for example. The cutting tools 20 to 34 each have the same nominal diameter, e.g., 70 mm, which is less than the inner diameter of the bore to be machined. A clamping screw 14 screwed into the tool base body 10 on the front side clamps the cutting tools 20 to 34 against a shaft-side axial stop formed on the tool base body 10. The clamping screw 14 is designed as a head screw, whose head 15 presses against the foremost cutting tool 20.

The cutting tools 20 to 34 each have the same structural design. For the sake of simplicity, the structural design of cutting tool 20 will be described below, since the structural design of cutting tools 21 to 34 is similar thereto.

FIG. 2 shows a front view of the circular miller 1. The cutting tool 20 has a disk-shaped milling base body 35, which carries a plurality of cutting elements 36 arranged in a row in the circumferential direction. Each cutting element 36 has a circumferential cutter 37, wherein the circumferential cutters 37 of the cutting elements 36 form a circumferential cutter set of the cutting tool 20. In the exemplary embodiment shown, the cutting tool 20 has eight cutting elements 36. As a consequence, the circumferential cutter set of the cutting tool 20 has eight circumferential cutters 37, which in the embodiment shown are uniformly distributed over the circumference of the cutting tool 20. The circumferential cutter set of the cutting tool 20 has first circumferential cutters 38, second circumferential cutters 39, and third circumferential cutters 40, which each have a cutting profile that differs from the end profile, in particular corresponds to part of the end profile.

In the embodiment shown, the circumferential cutter set of the cutting tool 20 has two first circumferential cutters 38, two second circumferential cutters 39, and four third circumferential cutters 40. As evident from FIG. 2, the first circumferential cutters 38 are arranged opposite each other, i.e., offset by 180° in the circumferential direction. The second circumferential cutters 39 are arranged opposite each other, i.e., offset by 180° in the circumferential direction, and between the first circumferential cutters 38, i.e., offset by 90° in the circumferential direction to the first circumferential cutters 38. As a consequence, the first circumferential cutters 38 and second circumferential cutters 39 are arranged so as to regularly alternate in the circumferential direction. The third circumferential cutters 40 are each arranged offset relative to each other by 90° in the circumferential direction, and each arranged between a first circumferential cutter 38 and a second circumferential cutter 39, i.e., offset by 45° in the circumferential direction to a first circumferential cutter 38 and a second circumferential cutter 39. Therefore, the circumferential cutters 37 arranged in a row in the circumferential direction come to be arranged as follows: First circumferential cutter 38, third circumferential cutter 40, second circumferential cutter 39, third circumferential cutter 40, first circumferential cutter 38, third circumferential cutter 40, second circumferential cutter 39, third circumferential cutter 40.

The first circumferential cutters 38, second circumferential cutters 39 and third circumferential cutters 40 each have a cutting profile that differs both from the end profile and from the cutting profiles of the respective other circumferential cutters 38, 39, 40. The cutting profiles of the first circumferential cutters 38, second circumferential cutters 39 and third circumferential cutters 40 thus leave behind different cut marks in a machined bore surface. Therefore, the cutting profiles of the first circumferential cutters 38, second circumferential cutters 39 and third circumferential cutters 40 engage into the bore surface to be machined in such a way that they each produce only a part of the end profile, i.e., a partial profile, but together yield the complete end profile. This is achieved by virtue of the fact that the cutting profiles of the first circumferential cutters 38, second circumferential cutters 39 and third circumferential cutters 40 projected in the circumferential direction overlap each other according to the invention in such a way or to such an extent in an axial direction and/or in a radial direction as to together image the end profile.

As a result, the circular milling tool 1 works as follows: If the circular milling tool 1 is driven in the rotational direction, the first, second and third circumferential cutters 38, 39, 40 cut into the bore to be machined one after the other. In this way, each of the first, second and third circumferential cutters 38, 39, 40 remove material, so as to image a part of the end profile. In other words, the first circumferential cutters 38 cut a first cut mark, which is a part of the end profile, i.e., a partial profile, and corresponds to the cutting profile of the first circumferential cutters 38, into the bore surface. The profile surface of the first cut mark is here smaller than the profile surface of the end profile, for example the first cut mark has a groove profile with a smaller groove width. As the circular milling tool 1 continues turning around its axis of rotation 2, the third circumferential cutters 40 cut a third cut mark, which is a partial profile of the end profile and corresponds to the cutting profile of the third circumferential cutters 40, into the bore surface. The third cut mark here differs from the end profile; for example, the third cut mark lies on a smaller diameter around the bore axis than the first cut mark. As the circular milling tool 1 continues to turn around its axis of rotation 2, the second circumferential cutters 39 cut a second cut mark, which is part of the end profile and corresponds to the shape of the cutting profile of the second circumferential cutters 39, into the bore surface. Similarly to the first cut mark, the profile surface of the second cut mark is smaller than the profile surface of the end profile; for example, the second cut mark has a groove profile with a smaller groove width than the end profile, but deviates from the first cut mark; for example, the second cut mark has a groove profile with the same groove width as the first cut mark, but is axially offset. In the preferred embodiment, the first and second cut mark overlap each other in the axial direction for the most part, for example by more than 80% of the respective groove width.

FIG. 3 shows a cutting element 36 that forms the first circumferential cutters 38. The cutting profile of the first circumferential cutter 38 has a plurality of cutting teeth 38a, which are spaced apart from each other at identical axial tooth distances and each have the same tooth width and tooth height. The cutting teeth 38a thus have a constant axial pitch. In the embodiment shown, the cutting teeth 38a of the first circumferential cutter 38 each have a rectangular profile. The tooth width B₃₈ₐ is measured as the distance between a front tooth flank 38b (in an axial infeed direction of the circular milling tool) and a rear tooth flank 38c (in the axial infeed direction of the circular milling tool) of a cutting tooth 38a. The tooth height H₃₈ₐ is measured as the distance between a tooth base 38d and a tooth tip 38e. Each tooth base 38d of the cutting teeth 38a lies on a constant tooth base diameter D_{38d}. Each tooth tip 38e of the cutting teeth 38a lies on a constant tooth tip diameter D38e, which also comprises the diameter D₃₈ of the first circumferential cutter 38. The axial tooth distance A₃₈ₐ is here measured as the distance between the rear tooth flank 38c of a cutting tooth 38a and a front tooth flank 38b of a cutting tooth 38a that is adjacent thereto and arranged behind it in the axial infeed direction of the circular milling tool 1. The axial pitch T₃₈ₐ at which the cutting teeth 38a are arranged is measured as the distance between the front tooth flanks 38b of a respective two cutting teeth 38a adjacent in the axial direction. Therefore, the axial pitch T₃₈ₐ corresponds to the sum of the axial tooth distance A₃₈ₐ and the tooth width B₃₈ₐ. Each first circumferential cutter 38 has an overall width B₃₈.

FIGS. 4a and 4b show two variants of a cutting element 36, which comprises one of the second circumferential cutters 39. The cutting profile of each second circumferential cutter 39 has a plurality of cutting teeth 39a, which are arranged spaced apart at identical axial tooth distances from each other, and each have the same tooth width and tooth height. The cutting teeth 39a thus have a constant axial pitch. In the embodiment shown, the cutting teeth 39a of the second circumferential cutters 39 each have a rectangular profile. The tooth width B₃₉ₐ is measured as the distance between a front tooth flank 39b (in the infeed direction of the circular milling tool) and a rear tooth flank 39c (in the infeed direction of the circular milling tool) of a cutting tooth 39a. The tooth height H₃₉ₐ is measured as the distance between a tooth base 39d and a tooth tip 39e. Each tooth base 39d of the cutting teeth 39a lies on a constant tooth base diameter D_{39d}. Each tooth tip 39e of the cutting teeth 39a lies on a constant tooth tip diameter D₃₉ₑ, which also comprises the diameter D₃₉ of the second circumferential cutter 39. The axial tooth distance A₃₉ₐ is measured as the distance between a rear tooth flank 39c of a cutting tooth 39a and a front tooth flank 39b of a cutting tooth 39a that is adjacent thereto and arranged behind it in the axial infeed direction of the circular milling tool 1. The axial pitch T₃₉ₐ at which the cutting teeth 39a are arranged is measured as the distance between the front tooth flanks 39b of a respective two cutting teeth 39a adjacent in the axial direction. Therefore, the axial pitch T₃₉ₐ corresponds to the sum of the axial tooth distance A₃₉ₐ and the tooth width B₃₉ₐ. Each first circumferential cutter 39 has an overall width B₃₉.

In the embodiment shown, the cutting profile of a first circumferential cutter 38 (see FIG. 3) corresponds to the cutting profile of a second circumferential cutter 39 (see FIGS. 4a and 4b) with regard to the axial pitch of the cutting teeth 38a or 39a (T₃₈ₐ=T₃₉ₐ), the axial tooth distance of the cutting teeth 38a or 39a (A₃₈ₐ=A₃₉ₐ), the tooth width of the cutting teeth 38a or 39a (B₃₈ₐ=B₃₉ₐ), the tooth height of the cutting teeth 38a or 39a (H₃₈ₐ=H₃₉ₐ), the tooth base diameter (D_{38d}=D_{39d}), the tooth tip diameter (D₃₈ₑ=D₃₉ₑ), the diameter of the circumferential cutters 38 or 39 (D₃₈=D₃₉) as well as the overall width of the circumferential cutter 38 or 39 (B₃₈=B₃₉). The cutting profile of a circumferential cutter 39 shown on FIG. 4a differs from the cutting profile of the circumferential cutter 38 shown on FIG. 3 in that the cutting teeth 39a are arranged around an offset V axially offset relative to the cutting teeth 38a, but the second circumferential cutter 39 is axially arranged at the same height as the first circumferential cutter 38. The cutting profile of a circumferential cutter 39 shown on FIG. 4b has the same cutting profile as a circumferential cutter 38 shown on FIG. 3, but the second circumferential cutter 39 shown on FIG. 4b is arranged around the offset V axially offset relative to the first circumferential cutter 38. To provide a better understanding, the offset V in the embodiment depicted is not to scale, but rather magnified.

The variants shown on FIGS. 4a and 4b are now possible for producing a different groove profile in a bore surface: (1) The circumferential cutters 38 and 39 are arranged at the same height in an axial direction, while the cutting teeth 38a of the circumferential cutter 39 are axially offset relative to the cutting teeth 38a of the circumferential cutter 38 by offset V, as shown on FIG. 4a, or (2) the identically designed second circumferential cutters 38 and 39 are axially offset relative to each other by offset V, as shown on FIG. 4b.

FIG. 5 shows a cutting element 36, which comprises one of the third circumferential cutters 40. The cutting profile of every third circumferential cutter 40 has a single-tooth design. In the embodiment shown, the one cutting tooth 40a of every third circumferential cutter 40 has a wavy profile, as depicted on FIG. 5. The third circumferential cutter 40 has an overall width B₄₀. The cutting profile of the third circumferential cutter 40 is configured so as to machine the webs S between the grooves of the end profile of a machined bore surface to a predefined diameter D_{R}. The third circumferential cutters 40 thus lie on a smaller diameter D₄₀ than the first circumferential cutters 38 (D₃₈>D₄₀) and the second circumferential cutters (D₃₉>D₄₀). However, the diameter D₄₀ of the third circumferential cutters 40 is greater than the tooth base diameter D_{38d} of the first circumferential cutters 38 (D_{38d}<D₄₀) and the tooth base diameter D_{39d} of the second circumferential cutters 39 (D_{39d}<D₄₀)

FIG. 6 shows the end profile, which results from overlapping the cut marks left behind in a machined bore surface or partial profiles of the circumferential cutters 38, 39 and 40 of a circumferential cutter set. The end profile has a plurality of microgrooves, which each have the same groove width B_{R} and groove depth H_{R}. The webs S are arranged between adjacent microgrooves, and each have the same web width B_{S}. As a result, the microgrooves have a constant axial pitch T_{R}. The groove width B_{R} is measured as the distance between a front groove flank VRF and a rear groove flank HRF of a microgroove. The groove depth H_{R} is measured as the distance between a groove base RG and a web tip SS. The web width B_{S} is measured as the distance between a rear groove flank HRF of a microgroove and a front groove flank VRF of a microgroove adjacent thereto and arranged behind it in the axial infeed direction of the circular milling tool. The axial pitch T_{R} at which the microgrooves are arranged is measured as the distance between the front groove flanks VRF of two respective microgrooves adjacent in an axial direction. The web tips SS lie on a diameter that comprises the inner diameter D_{R} of the microgrooves. The microgrooves of the end profile have a groove width B_{R} and a groove depth H_{R}. The groove width B_{R} is greater than the tooth width B₃₈ₐ or B₃₉ₐ (B_{R}>B₃₈ₐ, B_{R}>B₃₉ₐ) the groove depth H_{R} is less than the tooth height H₃₈ₐ or H₃₉ₐ (H_{R}<H₃₈ₐ, H_{R}<H₃₉ₐ) the axial pitch T_{R} corresponds to the axial pitch T₃₈ or T₃₉ (T_{R}=T₃₈, T_{R}=T₃₉) and the diameter D_{R} of the end profile is less than the diameter D₃₈ or D₃₉ (D_{R}<D₃₈, D_{R}<D₃₉) , equal to the diameter D₄₀ (D_{R}=D₄₀), and greater than the tooth base diameter D_{38d} or D_{39d} (D_{R}<D_{38d}, D_{R}>D_{39d}).

FIGS. 7 to 9 schematically depict a cutout of the end profile of the machined bore surface and the engagement of the first, second or third circumferential cutters 38, 39, 40 into the end profile. The first circumferential cutter 38 machines the rear groove flanks HRF of the end profile with its rear tooth flanks 38c of the cutting teeth 38a, while the second circumferential cutter 39 machines the front groove flanks VRF of the end profile with its front tooth flanks 39b of the cutting teeth 39a. The groove base RG of the end profile is machined by the tooth tips 38d, 39d of the first or second circumferential cutter 38, 39. The third circumferential cutter 40 machines the webs S, and thus the diameter D_{R} of the end profile.

FIGS. 7 and 8 show that, as already mentioned, the tooth widths B₃₈ₐ, B₃₉ₐ of the cutting teeth 38a, 39a of the first and second circumferential cutters 38, 39 are smaller than the groove width BR between the front groove flank VRF and rear groove flank HRF. FIG. 9 shows that, as already mentioned, the webs S between the microgrooves of the end profile are brought to the diameter D_{R} by the third circumferential cutters 40. As a consequence, the chipping load for producing the end profile is distributed to the first, second and third circumferential cutters 38, 39, 40, which each only produce a part of the end profile.

FIG. 10 shows a perspective view of the first preferred embodiment of the circular milling tool 1. The cutting tools 20 to 34 are force-locked to the tool base body 10. Modeled after the circular milling tool indicated in DE 10 2016 216 464 A1, the cutting tools 20 to 34 receive the peg-like carrier section 12 with their respective center recess. The cutting tools 20 to 34 are non-rotatably fixed relative to the tool base body 10 in the circumferential direction by means of a tappet, for example a feather key. The cutting tools 20 to 34 are twisted relative to each other, so that the first, second and third circumferential cutters 38, 39, 40 each run along helical lines or coils. What this means is that a respective two axially directly sequential circumferential cutter sets are twisted relative to each other by a predefined angle. The first circumferential cutters 38 or second circumferential cutters 39 or third circumferential cutters 40 of two axially sequentially arranged cutting tools are arranged one after the other in the circumferential direction or rotational direction, so that they cut into the cylindrical surface to be machined in a time-displaced manner. This results in coiled chip grooves 16, the number of which corresponds to the number of circumferential cutters 37 per circumferential cutter set. In the exemplary embodiment shown, eight chip grooves 16 are formed. Viewed as a whole, the cutting part 13 of the circular milling tool 1 is helically grooved in design. The circumferential cutters 37 of two respective axially directly sequential circumferential cutter sets overlap each other in the axial direction. In the embodiment shown on FIG. 10, the circumferential cutters 37 are each indirectly secured to the tool base body 10 via the cutting tools 20 to 34.

FIGS. 11 to 13 show a second preferred embodiment of the circular milling tool 1 according to the invention. The second preferred embodiment essentially corresponds to the first preferred embodiment. For this reason, only the differences will be described below. The circumferential cutters 37 are each formed on a cutting element 50, and the cutting elements 50 are individually secured to a carrier section 12 of the tool base body 10. As opposed to the first embodiment, the circumferential cutters 37 are not indirectly fixed by a respective cutting tool 20 to 34, but directly fixed to the tool base body 10. To this end, each cutting element 50 is arranged in a pocketlike recess on the carrier section 12 of the tool base body 10, and screwed to the carrier section 12. Several cutting elements 50 axially arranged at the same height and distributed uniformly over the circumference comprise a circumferential cutter set. The circumferential cutter set has the first circumferential cutters 38 described above and second circumferential cutters 39 described above. The circumferential cutter set can also have third circumferential cutters 40 described above.

As shown on FIG. 14, the cutting elements 50 are formed in two parts, and have a carrier 50a and a cutting body 50b fastened thereto, e.g., soldered or adhesively bonded. For example, the cutting body 50b can be made out of PKD, CBN or a comparable hard material, while the carrier body 50a can be made out of solid carbide, steel, or the like, for example.

1. A circular milling tool for producing a microgroove structure in a cylindrical surface of a bore, wherein the microgroove structure has a groove profile that is defined by a plurality of microgrooves that are axially spaced apart and peripherally extend in a circular manner, comprising:
a tool base body that can be driven around an axis of rotation, which carries a circumferential cutter set with a first circumferential cutter and a second circumferential cutter, which are arranged in a row in the circumferential direction,
the first circumferential cutter and second circumferential cutter each have a cutting profile that differs from the groove profile of the microgroove structure to be produced, and
the circumferentially projected cutting profiles of the circumferential cutters of the circumferential cutter set overlap each other in an axial direction to an extent that they jointly image the defined groove profile of the microgroove structure to be generated.

2. The circular milling tool according to claim 1, wherein the first circumferential cutter and the second circumferential cutter each have a cutting profile that has a plurality of cutting teeth in the axial direction.

3. The circular milling tool according to claim 2, wherein the cutting teeth of the first circumferential cutter and/or the second circumferential cutter each have a rectangular tooth profile.

4. The circular milling tool according to claim 2, wherein the cutting teeth of the first circumferential cutter and/or the second circumferential cutter are arranged at the same axial distances.

5. The circular milling tool according to claim 2, wherein the cutting teeth of the first circumferential cutter and/or the second circumferential cutter have the same tooth widths.

6. The circular milling tool according to claim 1, wherein the first circumferential cutter and the second circumferential cutter lie on the same diameter.

7. The circular milling tool according to claim 1, wherein the circumferential cutter set comprises at least two first circumferential cutters and at least two second circumferential cutters, which are alternatingly arranged in the circumferential direction.

8. The circular milling tool according to claim 1, wherein the circumferential cutter set comprises a third circumferential cutter, which has a cutting profile different from the cutting profile of the first circumferential cutter and/or the cutting profile of the second circumferential cutter and/or from the defined groove profile of the microstructure to be produced.

9. The circular milling tool according to claim 8, wherein the third circumferential cutter is arranged between the first circumferential cutter and the second circumferential cutter.

10. The circular milling tool according to claim 8, wherein the third circumferential cutter lies on a smaller diameter than the first circumferential cutter and/or the second circumferential cutter.

11. The circular milling tool according to claim 8, wherein the third circumferential cutter has a single-tooth cutting profile.

12. The circular milling tool according to claim 11, wherein a cutting tooth of the single-tooth cutting profile of the third circumferential cutter has an axial tooth width that is essentially as large as a cutting width of the first circumferential cutter and/or a of the second circumferential cutter.

13. The circular milling tool according to claim 8, wherein the third circumferential cutter has a wavy cutting profile.

14. The circular milling tool according to claim 8, wherein third circumferential cutters set comprises several third circumferential cutters, which each are arranged between one of the first circumferential cutters and one of the second circumferential cutters.

15. The circular milling tool according to claim 14, wherein the circumferential cutter set has a higher number of third circumferential cutters than first circumferential cutters and/or second circumferential cutters.

16. The circular milling tool according to claim 1, wherein the circular milling tool comprises a plurality of axially staggered circumferential cutter sets.

17. The circular milling tool according to claim 16, wherein a respective two axially directly sequential circumferential cutter sets are twisted against each other around the axis of rotation by a predefined angle.

18. The circular milling tool according to claim 17, wherein a respective two axially directly sequential circumferential cutter sets overlap each other in an axial direction.

19. The circular milling tool according to claim 1, wherein the circumferential cutters are each formed on a cutting element indirectly indirectly or directly secured to a tool base body.

20. The circular milling tool according to claim 19, wherein the cutting elements are secured to a side milling cutter carried by the tool base body.

21. The circular milling tool according to claim 1, wherein the circular milling tool comprises a number of chip grooves corresponding to the number of circumferential cutters of the circumferential cutter set.

22. The circular milling tool according to claim 1, wherein the tool base body has a carrier section that carries the circumferential cutter set and a shaft section axially adjoining the carrier section for connecting the circular milling tool with a separating point or interface of a machine tool system.

23. A method for producing a microgroove structure in a bore the microgroove structure comprising a plurality of microgrooves that are axially spaced apart and peripherally extend in a circular manner, and each have a defined groove profile, by means of a rotary driven circular milling tool circulating around an axis of the bore, wherein
the bore surface is finished by a 360° circulation of a rotary driven circular milling tool according to claim 1 by virtue of the fact that the cut marks of the circumferential cutters per circumferential cutter set of the circular milling tool that were left behind in the bore surface overlap each other in an axial direction in such a way that they image the defined groove profile of the microgroove structure.

24. The circular milling tool according to claim 1, wherein the circumferential cutter set has a quantity of two first circumferential cutters, which are alternatingly arranged in the circumferential direction.

25. The circular milling tool according to claim 8, wherein the circumferential cutter set comprises four third circumferential cutters, which each are arranged between one of the first circumferential cutters and one of the second circumferential cutters.
